(19) United States
(12) Patent Application Publication
(10) Pub. No.: US 2006/0111470 A1
(43) Pub. Date: May 25, 2006

(54) Metal resin composite and process for producing the same

(76) Inventors: Masayuki Takashima, Fukui (JP); Susumu Yonezawa, Fukui (JP); Yuichi Matsumura, Fukui (JP)

Correspondence Address: FULBRIGHT & JAWORSKI, LLP, 666 FIFTH AVE, NEW YORK, NY, 10103-3198, US

(21) Appl. No.: 10/532,257

(22) PCT Filed: Oct. 21, 2003
(86) PCT No.: PCT/JP03/13448

§ 371 Date: Jan. 13, 2006

(30) Foreign Application Priority Data
Oct. 21, 2002 (JP) 2002-306152

(51) Int. Cl. C08K 9/12; C08K 3/08

(52) U.S. Cl. 523/210; 524/439

(57) ABSTRACT

Numerous particles of thermoplastic resin supporting a metal on surfaces thereof are joined together by pressure welding. The metal is supported in a three-dimensional matrix on the group of joined particles.

The present invention relates to a metal resin composite and a manufacturing method therefor.

### BACKGROUND ART

As an example of metal resin composites, there is an antibacterial resin. This antibacterial resin has, distributed in a resin, support grains with metal supported in an inorganic oxide (see Patent Application “Kokai” No. 10-7916, for example).

In the conventional metal resin composite noted above, because the support grains with metal supported in the inorganic oxide are distributed in the resin, the metal together with the support grains tends to be unevenly distributed in the resin owing to the difference in specific gravity between the support grains and the resin, and thus a drawback that uniform physical properties cannot be secured easily.

This invention has been made having regard to the state of the art noted above, and its object is to provide a metal resin composite and a manufacturing method therefor, which allow uniform physical properties to be secured with ease.

### DISCLOSURE OF THE INVENTION

A first characteristic construction of a metal resin composite according to the present invention lies in that numerous particles of thermoplastic resin are joined together, and a metal is supported in a three-dimensional matrix on a group of joined particles.

With this construction, since a metal is supported in a three-dimensional matrix on the group of particles joined together, the metal and resin are evenly distributed over the entire metal resin composite. This allows the physical properties of the metal resin composite to be secured uniformly.

A second characteristic construction of the metal resin composite according to the present invention lies in that the thermoplastic resin is at least one material selected from the group consisting of polytetrafluoroethylene, polyethylene, polypropylene, ABS resin, polyamide, polysulfone, AS resin, polystyrene, vinylidene chloride resin, vinylidene fluoride resin, PFA resin, polyphenylene ether, methyl pentene resin and methacrylic resin.

This construction allows the physical properties of the metal resin composite to be secured with increased uniformity.

A first characteristic means of a metal resin composite manufacturing method according to the present invention, which is a method of manufacturing the metal resin composite having the first characteristic construction, lies in causing the metal to be supported on surfaces of said particles, and pressure-welding and joining together the numerous particles supporting said metal.

With this means, each particle is caused to support a metal on its surface beforehand, and the numerous particles supporting the metal are pressure-welded and joined together. It is therefore easy to distribute the metal uniformly in the resin irrespective of a difference in specific gravity between support particles and resin. A metal resin composite with uniform physical properties can be manufactured easily. Even a thin and flexible conductive formed body can be manufactured easily.

A second characteristic means of the metal resin composite manufacturing method according to the present invention lies in that the surfaces of said particles are treated with an electroless metal plating to form a metal coating thereon, thereby causing the metal to be supported on surfaces of said particles.

With this means, manufacture at low cost is made possible by using existing electroless metal plating equipment.

A third characteristic means of the metal resin composite manufacturing method according to the present invention lies in that the surfaces of said particles are treated with an electroless plating in a solution having a metallic compound dissolved and fine grains other than metal distributed therein, to form a metal coating containing said fine grains other than metal, thereby causing the metal to be supported on surfaces of said particles.

With this means, manufacture at low cost is made possible by using existing electroless metal plating equipment. Besides, since the numerous particles having formed thereon the metal coating containing the fine grains other than metal are pressure-welded and joined together, it is possible to give the product the characteristics and physical properties of the fine grains other than metal also.

A fourth characteristic means of a metal resin composite manufacturing method according to the present invention, which is a method of manufacturing the metal resin composite having the first characteristic construction, lies in treating the surfaces of said particles with an electroless metal plating to form a metal coating thereon, thereby causing the metal to be supported on surfaces of said particles; treating the surfaces of said metal coating with an electrolytic plating in a solution having a metallic compound dissolved and fine grains other than metal distributed therein, to form an electrolytic plating film of metal containing said fine grains other than metal; and pressure-welding and joining together the numerous particles having said metal coating and said electrolytic plating film.

With this means, each particle is caused to support a metal on its surface beforehand, and the numerous particles supporting the metal are pressure-welded and joined together. It is therefore easy to distribute the metal uniformly in the resin irrespective of a difference in specific gravity between support particles and resin. A metal resin composite with uniform physical properties can be manufactured easily. Even a thin and flexible conductive formed body can be manufactured easily.

For causing the metal to be supported on the surfaces of the particles, a metal coating is formed on the surfaces of the particles by performing electroless metal plating. Thus, manufacture at low cost is made possible by using existing electroless metal plating equipment.

Besides, an electrolytic plating film of metal containing fine grains other than metal is formed on the surfaces of the particles by performing electrolytic plating in a solution having a metallic compound dissolved and fine grains other than metal distributed therein. The numerous particles having the metal coating and electrolytic plating film are pressure-welded and joined together. It is therefore possible to give the product the characteristics and physical properties of the fine grains other than metal also. By forming an electrolytic plating film of metal containing fine grains of a fluorine compound, for example, the surfaces of the metal resin composite may easily be joined, through the grains of the fluorine compound, with a fluororesin ion-exchange membrane having hydrogen ion conductivity and acting as a solid polymer electrolyte membrane. It is possible to manufacture easily metal resin compositees suited for manufacture of electrolyte composites for a polymer electrolyte fuel cell (PEFC) with the self-support of the fluororesin ion-exchange membrane is assisted, by joining metal resin composites as electrodes for the fuel cell to opposite surfaces of the fluororesin ion-exchange membrane.

A fifth characteristic means of the metal resin composite manufacturing method according to the present invention lies in that the particles are 0.1 μm to 1,000 μm in diameter.

With this means, metal resin composites of various sizes and forms can be manufactured with high accuracy.

A sixth characteristic means of the metal resin composite manufacturing method according to the present invention lies in that the metal coating is a film selected from the group consisting of Ni film, Ni alloy film, Ni compound film, Cu film, Cu alloy film, Cu compound film, Au film, Pt film, Pt alloy film, Pd film, Rh film and Ru film.

With this means, a uniform distribution in the resin is achieved easily to facilitate manufacture of a metal resin composite with uniform physical properties. Even a thin and flexible conductive formed body can be manufactured easily.

A seventh characteristic means of the metal resin composite manufacturing method according to the present invention lies in that the metal coating is a film selected from the group consisting of Ni—P, Ni—B, Ni—Cu—P, Ni—Co—P and Ni—Cu—B.

With this means, a metal resin composite having physical properties of increased uniformity may be manufactured easily.

An eighth characteristic means of the metal resin composite manufacturing method according to the present invention lies in that the fine grains other than metal are at least one material selected from the group consisting of polytetrafluoroethylene (PTFE), polyethylene (PE), polypropylene (PP), ABS resin, polyamide (PA), polysulfone (PSU), AS resin, polystyrene (PS), vinylidene chloride resin (PVDC), vinylidene fluoride resin, PFA resin, polyphenylene ether (PFE), methyl pentene resin, methacrylic resin, carbon (C), catalyst support grains and thermosetting resin.

With this means, the metal resin composite can be given the characteristics and physical properties of the fine grains of the above compounds.

### BRIEF DESCRIPTION OF THE DRAWINGS

FIG. 1 is a metallographic micrograph (section) of a metal resin composite;

FIG. 2 is a schematic view illustrating a manufacturing method in a first embodiment;

FIG. 3 is a micrograph of particles having porous metal coating formed on surfaces thereof,

FIG. 4 is a schematic view illustrating a manufacturing method in a second embodiment; and

FIG. 5 is a schematic view illustrating a manufacturing method in a third embodiment.

### BEST MODE FOR CARRYING OUT THE INVENTION

Embodiments of the present invention will be described hereinafter with reference to the drawings.

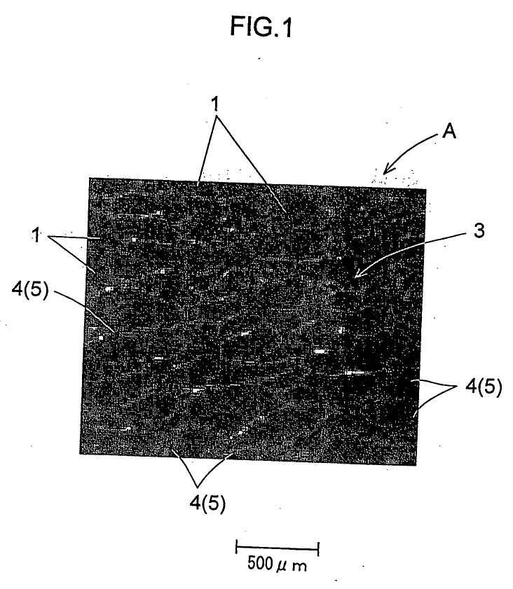

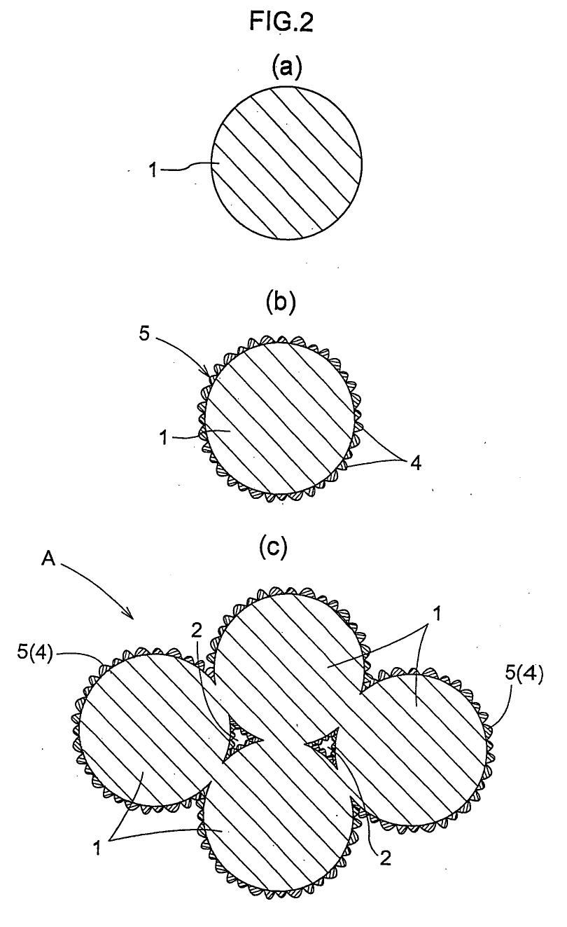

FIG. 1 shows a metallographic micrograph of a section of a metal resin composite A according to the present invention. Numerous particles 1 of thermoplastic resin, as schematically shown in FIG. 2, are joined together to form air passages 2 among the particles 1. A group of joined particles 3 supports metal 4 in form of matrices in three-dimensional directions to have conductivity.

A method of manufacturing the above metal resin composite A will be described.

FIG. 2 schematically shows particles 1 of 0.1 μm to 1,000 μm having porous metal coating 5 formed on the surfaces thereof. The porous metal coating 5 is formed by performing an electroless plating of metal on the surfaces of particles 1, whereby the metal is supported on the surfaces of particles 1 (FIGS. 2(a), (b)).

Numerous particles 1 having the metal coating 5 formed on the surfaces thereof are pressure-welded and joined together with the resins bound together, while controlling the pressure and temperature, by a shaping method such as flat sheet pressing, cold isostatical pressing (CIP), hot isostatical pressing (HIP), roll pressing, cold pressing or hot pressing (FIG. 2(c)). This manufactures the metal resin composite A excellent in conductivity as well as strength.

The thermoplastic resin forming the particles 1 is at least one material selected from the group consisting of polytetrafluoroethylene (PTFE), polyethylene (PE), polypropylene (PP), ABS resin, polyamide (PA), polysulfone (PSU), AS resin, polystyrene (PS), vinylidene chloride resin (PVDC), vinylidene fluoride resin, PFA resin, polyphenylene ether (PFE), methyl pentene resin and methacrylic resin. Such materials may easily be shaped to a desired form, and may be given a desired thickness of 10 μm to 10 mm.

The metal coating 5 may be a film selected from the group consisting of Ni film, Ni alloy film, Ni compound film, Cu film, Cu alloy film, Cu compound film, Au film, Pt film, Pt alloy film, Pd film, Rh film and Ru film, or may be a film selected from the group consisting of Ni—P, Ni—B, Ni—Cu—P, Ni—Co—P and Ni—Cu—B.

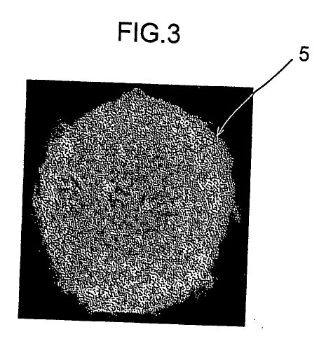

FIG. 3 is a micrograph of particles 1 having porous nickel film 5 formed on the surfaces thereof. Where the metal coating 5 is formed of nickel (Ni), the product may be used conveniently as an electrode material for polymer electrolyte fuel cells since corrosion resistance is high compared with copper or the like, and it can act also as a catalyst in the electrochemical reaction of hydrogen.

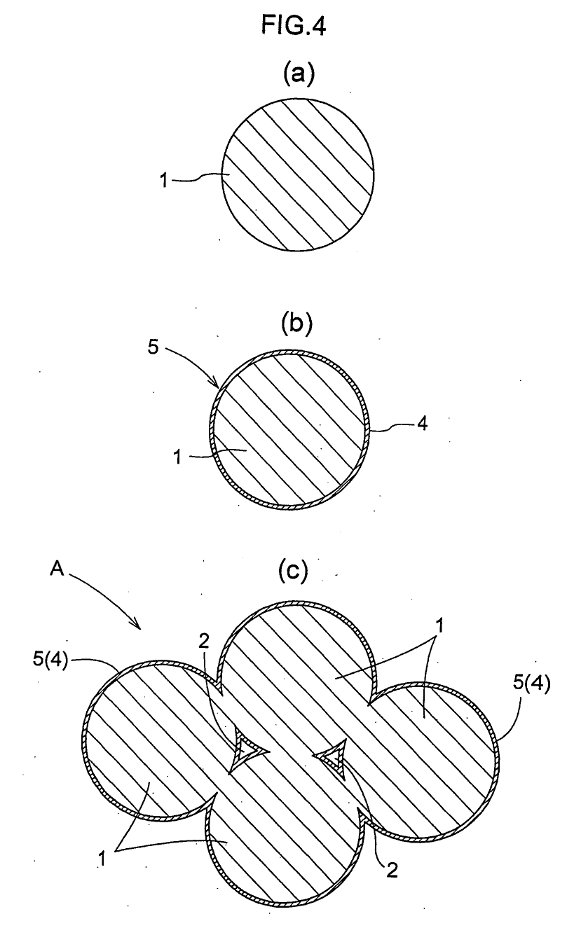

FIG. 4 schematically shows a method of manufacturing a metal resin composite A in a different embodiment. A continuous metal coating 5 is formed by an electroless plating of metal on the surfaces of particles 1 of 0.1 μm to 1,000 μm, whereby the metal is supported on the surfaces of particles 1 (FIGS. 4(a), (b)).

Numerous particles 1 having the metal coating 5 formed on the surfaces thereof are pressure-welded and joined together with the resins bound together, while controlling the pressure and temperature, by a shaping method such as flat sheet pressing, cold isostatical pressing (CIP), hot isostatical pressing (HIP), roll pressing, cold pressing or hot pressing (FIG. 2(c)). This manufactures the metal resin composite A excellent in conductivity as well as strength.

In time of pressure welding by the above pressurization, where the metal coating 5 covers the surfaces of particles 1 without gaps, the pressurization produces cracks in the metal coating 5 and the resins are bound together. Where the metal coating 5 is formed to have gaps between the metals, resin portions exposed through the gaps are bound together by the pressurization.

The other aspects are the same as in the first embodiment.

Though not shown, the surfaces of particles 1 may be subjected to an electroless plating in a solution having a metallic compound dissolved and fine grains other than metal, e.g. resin grains, distributed therein, thereby forming metal coating 5 containing the resin grains. Numerous particles 1 having the metal coating 5 formed on the surfaces of the resin grains are pressure-welded and joined together with the resins bound together, while controlling the pressure and temperature, by a shaping method such as flat sheet pressing, cold isostatical pressing (CIP), hot isostatical pressing (HIP), roll pressing, cold pressing or hot pressing. This manufactures a metal resin composite A having characteristics and physical properties of the resin grains, and excellent in conductivity as well as strength.

The fine grains other than metal are at least one material selected from the group consisting of polytetrafluoroethylene (PTFE), polyethylene (PE), polypropylene (PP), ABS resin, polyamide (PA), polysulfone (PSU), AS resin, polystyrene (PS), vinylidene chloride resin (PVDC), vinylidene fluoride resin, PFA resin, polyphenylene ether (PFE), methyl pentene resin, methacrylic resin, carbon (C), catalyst support grains and thermosetting resin.

The other aspects are the same as in the first embodiment.

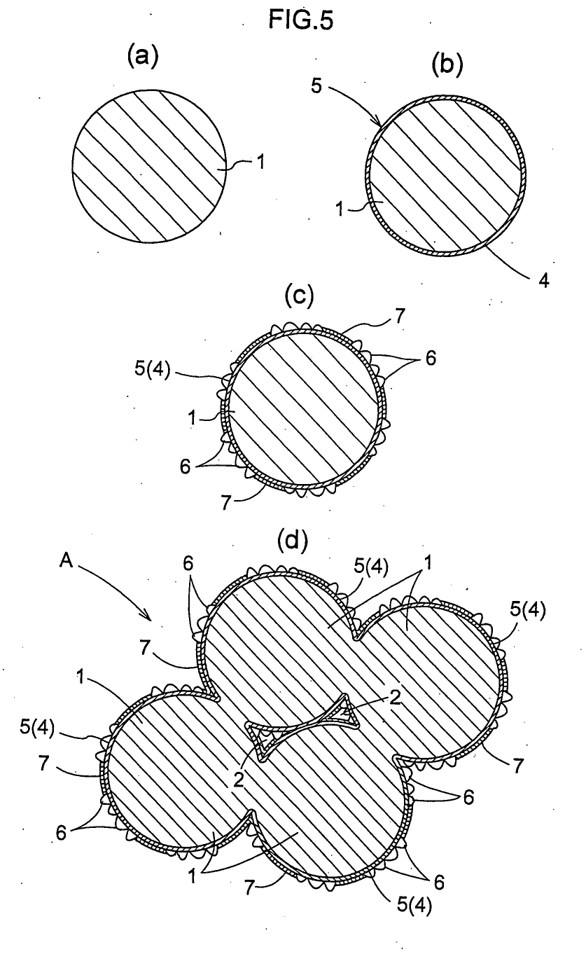

FIG. 5 schematically shows a method of manufacturing a metal resin composite A in a different embodiment. A continuous metal coating 5 is formed by an electroless plating of metal on the surfaces of particles 1 of 0.1 μm to 1,000 μm, whereby the metal is supported on the surfaces of particles 1 (FIGS. 5(a), (b)). Further, an electrolytic plating is performed on the surface of the metal coating 5 in a pyrophosphoric acid bath with fine grains of a fluorine compound (fine grains other than metal) 6 distributed therein, thereby forming an electrolytic plating film 7 of metal containing the fine grains of the fluorine compound 6 (FIG. 5(c)).

A method of forming the electrolytic plating film 7 is described in detail in Patent Application “Kokai” No. 9-106817, and will not be described herein.

Numerous particles 1 having the inner metal coating 5 and outer electrolytic plating film 7 on the surfaces thereof are pressure-welded and joined together, while controlling the pressure and temperature, by a shaping method such as flat sheet pressing, cold isostatical pressing (CIP), hot isostatical pressing (HIP), roll pressing, cold pressing or hot pressing, thereby forming cracks in the metal coating 5 and electrolytic plating film 7 to bind the resins (FIG. 5(d)). This manufactures a metal resin composite A excellent in conductivity as well as strength.

This embodiment joins together the numerous particles 1 having, formed on the surface of metal coating 5, the electrolytic plating film 7 including the fine grains of fluorine compound 6. Thus, through the fine grains of fluorine compound 6 included in the electrolytic plating film 7, the particles may easily be joined with a fluororesin ion exchange membrane having hydrogen ion conductivity and acting as a solid polymer type electrolyte membrane. By joining metal resin composites A as electrodes for fuel cells to the opposite surfaces of the fluororesin ion exchange membrane, electrolyte composites may be manufactured easily for solid polymer electrolyte fuel cells (PEFC), which assists self-support of the fluororesin ion exchange membrane.

The other aspects are the same as in the first embodiment.

In the metal resin composite and the manufacture method therefor according to the present invention, numerous particles of a thermoplastic resin may be joined together to define air passages among the particles, or may be joined together without air passage among the particles.

### EXAMPLE 1

Polytetrafluoroethylene (PTFE) was selected as thermoplastic resin, and a surface adjusting treatment was performed on PTFE particles 1 whose mean particle diameter was 20 μm, by using a fluoric cation surface active agent as surface-treating agent. Specifically, the PTFE particles 1 were agitated in an aqueous solution of 0.75 g/L[C₈F₁₇SO₂NH(CH₂)₃(CH₃)₂N⁺]I⁻ at 70° C. for 10 minutes, and were then thoroughly rinsed. As the surface-treating agent, also usable besides fluoric cation surface active agent are a cation surface active agent other than fluoric, an anion surface active agent and a nonion surface active agent.

After the surface treatment, the surfaces of PTFE particles 1 were catalytically activated by repeating twice a sensitivity applying treatment with a sensitizer, thorough rinsing, a catalyst applying treatment with an activator, and thorough rinsing. The catalytic activation of the surfaces may be carried out also by repeating a catalyst applying step and an activation step with a dilute acid, for example, besides the method described above.

Next, metal coating 5 is formed on the surfaces of PTFE particles 1 by electroless Ni plating. The bath composition and conditions of the Ni plating solution are shown in Table 1 below.

TABLE 1

| | |
|---|---|
| nickel sulfate | 15 g/L |
| sodium hypophosphite | 14 g/L |
| sodium hydroxide | 8 g/L |
| glycine | 20 g/L |
| pH | 9.5 |
| bath temperature | 60° C. |
| agitating time | 40 min. |

After the electroless Ni plating, an electrolytic Ni plating is performed on the PTFE particles 1, using the plating apparatus disclosed in Patent Application “Kokai” No. 9-106817. The bath composition and conditions of the Ni plating solution are shown in Table 2 below.

TABLE 2

| | |
|---|---|
| nickel sulfamate | 350 g/L |
| nickel chloride | 45 g/L |
| boric acid | 40 g/L |
| Ph | 4.5 |
| current density | 10 A/dm² |
| bath temperature | 50° C. |
| Anode | Ni plate |
| agitating time | 60 min. |

After the electrolytic Ni plating treatment, the particles were thoroughly rinsed and put to vacuum reduced pressure drying for one hour. The amount of plating was 65.2% by weight, and an average plating film thickness was 0.35 μm.

The Ni plated PTFE particles obtained in this way were pressure-formed, while performing vacuum degassing, in a flat press using a die with one surface shaped rugged, at 300° C. and 100 MPa for five minutes. This produced a formed body (metal resin composite A) with one surface rugged and the other surface planar, and 40 mm long, 40 mm wide 1 mm thick. An observation of sections of the formed body has confirmed that it is a porous body having gas permeability.

### EXAMPLE 2

Polymethyl methacrylate (PMMA) which is an example of methaciylic resin was selected as thermoplastic resin, and a surface adjusting treatment as in the first example and electroless Ni-PTFE plating were performed on PMMA particles 1 whose mean particle diameter was 10 μm, to form metal coating 5 on the surfaces of PMMA particles 1. The bath composition and conditions of the Ni-PTFE plating solution are shown in Table 3 below.

TABLE 3

| | |
|---|---|
| nickel sulfate | 15 g/L |
| sodium hypophosphite | 14 g/L |
| sodium hydroxide | 8 g/L |
| glycine | 20 g/L |
| PTFE (particle diameter: 0.3 μm) | 15 g/L |
| surface active agent | 0.5 g/L |
| pH | 9.5 |
| bath temperature | 90° C. |
| agitating time | 40 min. |

After the electroless Ni-PTFE plating treatment, the particles were thoroughly rinsed and put to vacuum reduced pressure drying for five hours. The amount of plating was 59.1% by weight, and an average plating film thickness was 0.32 μm.

The conductive particles obtained in this way were spread thin over a stainless plate, and roll-pressed in air atmosphere at 300° C. and with a linear pressure at 44.1 kN/cm. This produced a formed body (metal resin composite A) 40 mm long, 40 mm wide 100 μm thick.

### EXAMPLE 3

Polytetrafluoroethylene (PTFE) was selected as thermoplastic resin, and a surface adjusting treatment as in the first example and electroless Cu-PTFE plating were performed on PTFE particles 1 whose mean particle diameter was 20 μm, to form metal coating 5 on the surfaces of PTFE particles 1. The bath composition and conditions of the Cu-PTFE plating solution are shown in Table 4 below.

TABLE 4

| | |
|---|---|
| copper sulfate | 7 g/L |
| Potassium sodium tartrate | 20 g/L |
| sodium hydroxide | 10 g/L |
| formalin | 4 ml/L |
| pH | 12 |
| bath temperature | 30° C. |
| agitating time | 10 min. |
| | per 1 mL of formalin |

The plating solution is first treated with chemicals except formalin in Table 1. After placing the PTFE particles 1 in the plating solution, formalin was added 1 mL at a time while agitating the solution. The formalin injection was carried out at intervals of 10 minutes. After the plating, the particles were thoroughly rinsed and put to vacuum reduced pressure drying for one hour. The amount of plating was 58.7% by weight, and an average plating film thickness was 0.53 μm.

The conductive particles obtained in this way were filled into a rubber die 20 mm in diameter and 100 mm long, and were pressure-formed by cold isostatical pressing (CIP) at room temperature, with a pressure of 392 MPa, for one hour. The product was sliced with a microtome, to obtain a formed body (metal resin composite A) 100 mm long, 20 mm wide and 100 μm thick. FIG. 1 shows the result of part of this formed body observed under a microscope. As is clear from FIG. 1, the electroless copper plating film 5 is deposited uniformly on the PTFE particle surfaces, to form a three-dimensional electric conduction path matrix.

### INDUSTRIAL UTILITY

The metal resin composite according to the present invention can be conveniently used as an electrode material for a polymer electrolyte fuel cell. The metal resin composite manufacturing method according to the present invention can easily manufacture a metal resin composite suited for manufacturing an electrolyte composite for a polymer electrolyte fuel cells (PEFC).

1. A metal resin composite having numerous particles of thermoplastic resin joined together, and a metal supported in a three-dimensional matrix on a group of joined particles.

2. A metal resin composite as defined in claim 1, wherein said thermoplastic resin is at least one material selected from the group consisting of polytetrafluoroethylene (PTFE), polyethylene (PE), polypropylene (PP), ABS resin, polyamide (PA), polysulfone (PSU), AS resin, polystyrene (PS), vinylidene chloride resin (PVDC), vinylidene fluoride resin, PFA resin, polyphenylene ether (PFE), methyl pentene resin and methacrylic resin.

3. A method of manufacturing the metal resin composite defined in claim 1, the metal resin composite manufacturing method comprising:
causing the metal to be supported on surfaces of said particles; and
pressure-welding and joining together the numerous particles supporting said metal.

4. A metal resin composite manufacturing method as defined in claim 3, wherein the surfaces of said particles are treated with an electroless metal plating to form a metal coating thereon, thereby causing the metal to be supported on surfaces of said particles.

5. A metal resin composite manufacturing method as defined in claim 3, wherein the surfaces of said particles are treated with an electroless plating in a solution having a metallic compound dissolved and fine grains other than metal distributed therein, to form a metal coating containing said fine grains other than metal, thereby causing the metal to be supported on surfaces of said particles.

6. A method of manufacturing the metal resin composite defined in claim 1, the metal resin composite manufacturing method comprising:
treating the surfaces of said particles with an electroless metal plating to form a metal coating thereon, thereby causing the metal to be supported on surfaces of said particles;
treating the surfaces of said metal coating with an electrolytic plating in a solution having a metallic compound dissolved and fine grains other than metal distributed therein, to form an electrolytic plating film of metal containing said fine grains other than metal; and
pressure-welding and joining together the numerous particles having said metal coating and said electrolytic plating film

7. A metal resin composite manufacturing method as defined in claim 3, wherein said particles are 0.1 μm to 1,000 μm in diameter.

8. A metal resin composite manufacturing method as defined in claim 4, wherein said metal coating is a film selected from the group consisting of Ni film, Ni alloy film, Ni compound film, Cu film, Cu alloy film, Cu compound film, Au film, Pt film, Pt alloy film, Pd film, Rh film and Ru film.

9. A metal resin composite manufacturing method as defined in claim 4, wherein said metal coating is a film selected from the group consisting of Ni—P, Ni—B, Ni—Cu—P, Ni—Co—P and Ni—Cu—B.

10. A metal resin composite manufacturing method as defined in claim 5, wherein said fine grains other than metal are at least one material selected from the group consisting of polytetrafluoroethylene (PTFE), polyethylene (PE), polypropylene (PP), ABS resin, polyamide (PA), polysulfone (PSU), AS resin, polystyrene (PS), vinylidene chloride resin (PVDC), vinylidene fluoride resin, PFA resin, polyphenylene ether (PFE), methyl pentene resin, methacrylic resin, carbon (C), catalyst support grains and thermosetting resin.

11. A metal resin composite manufacturing method as defined in claim 4, wherein said particles are 0.1 μm to 1,000 μm in diameter.

12. A metal resin composite manufacturing method as defined in claim 5, wherein said particles are 0.1 μm to 1,000 μm in diameter.

13. A metal resin composite manufacturing method as defined in claim 6, wherein said particles are 0.1 μm to 1,000 μm in diameter.

14. A metal resin composite manufacturing method as defined in claim 5, wherein said metal coating is a film selected from the group consisting of Ni film, Ni alloy film, Ni compound film, Cu film, Cu alloy film, Cu compound film, Au film, Pt film, Pt alloy film, Pd film, Rh film and Ru film.

15. A metal resin composite manufacturing method as defined in claim 6, wherein said metal coating is a film selected from the group consisting of Ni film, Ni alloy film, Ni compound film, Cu film, Cu alloy film, Cu compound film, Au film, Pt film, Pt alloy film, Pd film, Rh film and Ru film.

16. A metal resin composite manufacturing method as defined in claim 5, wherein said metal coating is a film selected from the group consisting of Ni—P, Ni—B, Ni—Cu—P, Ni—Co—P and Ni—Cu—B.

17. A metal resin composite manufacturing method as defined in claim 6, wherein said metal coating is a film selected from the group consisting of Ni—P, Ni—B, Ni—Cu—P, Ni—Co—P and Ni—Cu—B.

18. A metal resin composite manufacturing method as defined in claim 6, wherein said fine grains other than metal are at least one material selected from the group consisting of polytetrafluoroethylene (PTFE), polyethylene (PE), polypropylene (PP), ABS resin, polyamide (PA), polysulfone (PSU), AS resin, polystyrene (PS), vinylidene chloride resin (PVDC), vinylidene fluoride resin, PFA resin, polyphenylene ether (PFE), methyl pentene resin, methacrylic resin, carbon (C), catalyst support grains and thermosetting resin.
